(19) United States
(12) Patent Application Publication
(10) Pub. No.: US 2010/0054326 A1
(43) Pub. Date: Mar. 4, 2010

(54) METHOD AND APPARATUS FOR DETECTING START AND END OF A VIDEO SEQUENCE

(75) Inventors: Joe Diamand, Del Mar, NJ (US); Haifeng Xu, San Diego, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/198,547

(22) Filed: Aug. 26, 2008

(51) Int. Cl. H04N 7/12

(52) U.S. Cl. 375/240.01; 375/E07.076

(57) ABSTRACT

A method and system for transcoding a video sequence having a plurality of frames are disclosed. For example, the method receives a video sequence having a plurality of frames in a first format. Then, the method detects at least one prefix frame in the video sequence. Subsequently, the method encodes the plurality of frames of the video sequence, beginning with a first frame of the plurality of frames, into a second format in response to detecting the at least one prefix frame. Then, the method detects at least one suffix frame in the video sequence having the plurality of frames. The method concludes by stopping the encoding of the plurality of frames after the last frame of the video sequence in response to detecting the at least one suffix frame.

### FIELD OF THE INVENTION

The present invention relates generally to processing a video sequence having a plurality of frames and, in particular, detecting start and end of a video sequence having a plurality of frames when decoding and encoding are performed on separate processors or processing modules.

### BACKGROUND OF THE INVENTION

There exists a category of set top boxes (STBs) that have the ability to store broadcast video for later replay and, utilizing this capability, the user may view video programming content at a more convenient time. This capability is usually referred to as digital video recorder (DVR) or personal video recorder (PVR).

A new twist on this capability re-targets traditional broadcast video content for display on mobile devices, such as video enabled mobile phones, portable media players, and the like. So, whereas the PVR enables time-shifting of the video program, the mobile devices facilitates place-shifting of the video program.

However, the time-shifted video content from the STB with PVR capability is targeted for a television. The format suitable for displaying the video content on a television may not be a suitable format for displaying the video content on a portable media player. Thus, the video content will need to be transcoded before it can be played on the portable media player.

Current methods of transcoding are inefficient because unnecessary frames may be transcoded in addition to the frames contained in the video content.

### BRIEF DESCRIPTION OF THE DRAWINGS

The teaching of the present invention can be readily understood by considering the following detailed description in conjunction with the accompanying drawings, in which:

FIG. 1 illustrates an exemplary high level block diagram of the present invention;

FIG. 2 illustrates an exemplary diagram of a system for transcoding a video sequence having a plurality of frames;

FIG. 3 illustrates an exemplary active indicator box;

FIG. 4 illustrates exemplary virtual pixels;

FIG. 5 illustrates an exemplary flow chart depicting a method for processing a video sequence having a plurality of frames;

FIG. 6 illustrates an alternate exemplary flow chart depicting a method for processing a video sequence having a plurality of frames; and

FIG. 7 illustrates a high level block diagram of an exemplary general purpose computer suitable for use in performing the functions described herein.

To facilitate understanding, identical reference numerals have been used, where possible, to designate identical elements that are common to the figures.

### DETAILED DESCRIPTION

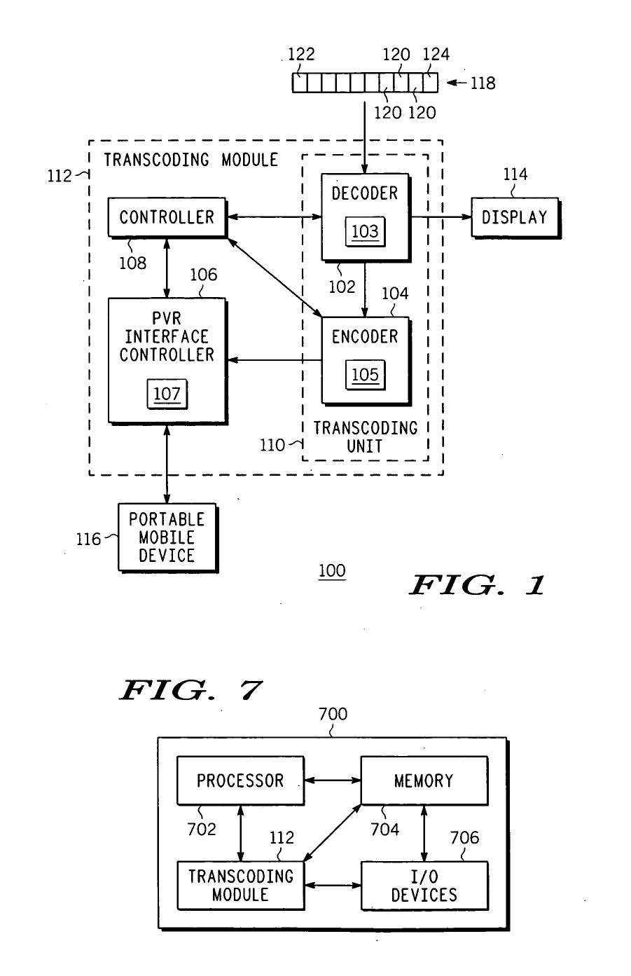

FIG. 1 illustrates an exemplary architectural overview of a transcoding system 100. In an exemplary embodiment, system 100 includes a decoder 102, an encoder 104, a personal video recorder (PVR) interface controller 106 and a controller 108. The controller 108 may be a master controller that relays information to and from the decoder 102, the encoder 104 and the PVR interface controller 106 as discussed below for transcoding a video sequence 118 having a plurality of frames 120.

In one embodiment, the video sequence 118 may be a portion of a larger video sequence that the user wishes to transcode to watch on a portable media device 116. For example, a user may wish to transfer only the actual game portions of a sporting event to their portable media device 116 and exclude all the pregame and postgame programming that was included in an original recording. However, without the present invention, the user would be forced to transcode the entire larger video sequence with unnecessary frames that the user does not wish to watch.

In an exemplary embodiment of the present invention, the decoder 102, the encoder 104, the PVR interface controller 106 and the controller 108 may be co-located on a single device, such as for example a set top box (STB) and be referred to collectively as a transcoding module 112. However, one skilled in the art will recognize that the decoder 102, the encoder 104, the PVR interface controller 106 and the controller 108 may also be implemented as one or more separate devices.

The transcoding of the video sequence 118 may be performed by the decoder 102 and the encoder 104. The decoder 102 and the encoder 104 may be collectively referred to as the transcoding unit 110. One skilled in the art will recognize that the decoder 102 and the encoder 104 may exist as separate devices or as a transcoding unit 110 on a single device, such as for example, a STB.

The decoder 102, the encoder 104, the PVR interface controller 106 and the controller 108 may be all connected via an analog or digital connection. For example, the digital connection may be a high definition multi-media interface (HDMI) connection and the like.

In one embodiment, the decoder 102 comprises a first processor 103 and optionally a storage medium (not shown) for storing received video sequences 118. Typically, the decoder 102 may decode and uncompress, if necessary, the video sequence 118 into a first format for viewing on a display 114, such as a television.

Alternatively, the video sequence 118 may be raw uncompressed video. If so, no information will be contained in the video sequence 118 that instructs the decoder 102 of the beginning or end of the video sequence 118. As a result, the controller 108 may be needed to provide the beginning and ending information of the video sequence 118 to the decoder 102.

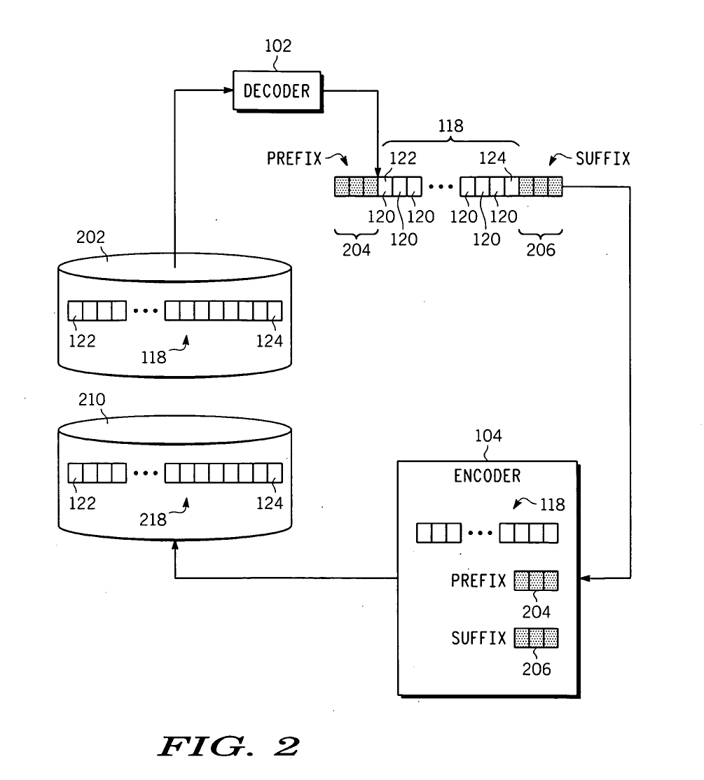

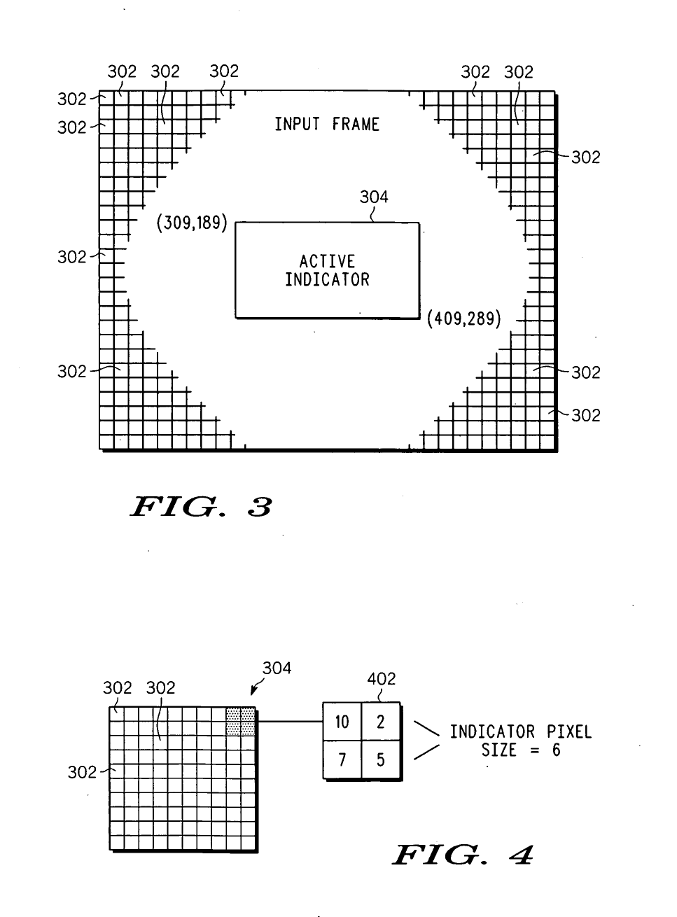

In an exemplary embodiment of the present invention, the decoder 102 may generate and insert at least one prefix frame and at least one suffix frame to the plurality of frames 120 of video sequence 118 for assisting the encoder 104 in performing a transcoding function. The prefix frame and suffix frame will be discussed in further detail with reference to FIGS. 2 and 3.

In one embodiment, the encoder 104 comprises a second processor 105. In an exemplary embodiment of the present invention, the encoder 104 receives a modified video sequence 118 from the decoder 102. For example, modified may mean that prefix and suffix frames are inserted into the video sequence 118. Then the encoder 104 begins encoding the modified video sequence 118 from a first format into a second format upon detecting the at least one prefix frame, for example, the encoder may start encoding with a frame 120 that immediately follows the at least one prefix frame (e.g. a first frame 122). The encoder then immediately stops encoding the modified video sequence 118 precisely after a last frame 124 when the encoder 104 detects the at least one suffix frame. Subsequently, the encoder 104 may output the transcoded video to the PVR interface controller 106.

In one embodiment, the PVR interface controller 106 comprises a third processor 107. The third processor may be, for example, an x86 processor. The PVR interface controller 106 may interface with a portable media device 116. The PVR interface controller 106 may be used to synchronize audio and the transcoded video for transmission to the portable media device 116. The PVR interface controller 106 may communicate with the portable media device 116 either via a wired connection, such as for example a high speed universal serial bus (USB) connection, a serial connection and the like or wirelessly via a wireless internet protocol (IP), cellular communications and the like. Alternatively, the PVR interface controller 106 may transfer the transcoded video onto a portable storage medium, such as for example, a memory card for uploading the content to the portable media device 116.

When a portable media device 116 communicates with the PVR interface controller 106 requesting a video sequence 118, the controller 108 may relay that information (e.g. the name or title of the requested video sequence, the display characteristics of the portable media device, and so on) to the decoder 102. When the decoder 102 locates the requested video sequence 118 (e.g. from a local storage device or a remotely located storage device), the decoder 102 informs the controller 108 to notify the encoder 104 to begin looking for the first prefix or suffix frame. Subsequently, the controller 108 may instruct the decoder 102 that the encoder is ready and to begin transmitting the requested video sequence 118 to the encoder 104 for transcoding. The encoder 104 then begins encoding when the first prefix frame is detected. The video sequence 118 must be transcoded in accordance with display parameters acceptable to the portable media device 116 because the portable media device 116 will not likely have the same resolution as the display 114 that the video sequence 118 was initially encoded for.

To maximize the efficiency of the transcoding, it is desirable to only encode from a first frame 122 of the video sequence 118 to a last frame 124 of the video sequence 118 that a user wishes to watch. However, with current methodologies, as discussed above, many unnecessary frames may be encoded. Unnecessary frames may be, for example, frames of video that a user does not want. As discussed above, if a user is attempting to transcode a sporting event onto their portable media device 116, they may not want to transcode any pregame events or commercials immediately before the sporting event or postgame events after the sporting event. These undesired video frames may be captured for example when a program is recorded based on electronic programming guide (EPG) data. For example, if the EPG data simply states that a sporting event is scheduled to begin at 8:00 pm, a recording device may begin recording at 8:00 pm even though the actual sporting event does not begin until 8:10 pm due to pregame programming. Alternatively, if a user desires to record a program at 8:00 pm, the program may not start until 8:15 pm due to delays caused by a sporting event that went over the scheduled time. Thus, user may have “unnecessary frames” that they do not wish to transcode for viewing on their portable media device 116.

Notably, because the video sequence 118 is uncompressed, the encoder 104 may not rely on information found in a header field typically used in compressed video. Moreover, out of band information may not be used because out of band information is incapable of instructing the encoder 104 of the precise beginning and end of the video sequence 118 due to the fact that the out of band instructions to and from the encoder 104 and decoder 102 occur in series.

A solution to this problem is provided in an exemplary embodiment of the present invention. In an exemplary embodiment, the decoder 102 adds at least one prefix frame and at least one suffix frame to the plurality of frames 120 of video sequence 118, as will be discussed now with reference to FIG. 2. The present invention also advantageously provides a less computationally demanding transcoding method when processing resources may be scarce.

FIG. 2 illustrates an exemplary diagram of a method for transcoding a video sequence 118 having a plurality of frames 120. As discussed above, the decoder may interact with a local storage medium 202 for storing video sequences 118. Optionally, the storage medium 202 may be located remotely at a head end. In an alternative embodiment, the video sequence 118 may be raw uncompressed video, for example, from a live broadcast that is not stored in a storage medium 202. However, the present exemplary diagram depicts the video sequence 118 being retrieved from a storage medium 202.

The video sequence 118 is fed to decoder 102 for decoding and uncompressing (if necessary). As discussed above, the decoder 102 may generate and insert at least one prefix frame 204 and at least one suffix frame 206 to the plurality of decoded frames 120 of video sequence 118. The at least one prefix frame 204 may be added before the first frame 122 of the video sequence 118. The at least one suffix frame 206 may be added after the last frame 124 of the video sequence 118. More specifically, the decoder 102 knows exactly where to place the at least one prefix frame 204 and the at least one suffix frame 206 because the decoder 102 is reading the video sequence 118 from a file on a storage medium 202 and knows when it is processing the start of a file as well as when it is processing the end of a file. For example, if a user only wants to watch the actual game portions of a sporting event, the decoder will know the beginning and the end of the actual game portion of the sporting event, e.g., from packet identifiers (PID) inserted into the video sequence 118 from a content provider. For example, a frame 120 that carries a commercial may have a different PID than a frame 120 that carries a pregame interview, a frame 120 that carries commentators discussing a sports event in a booth or a frame 120 that carries the actual game (e.g., kickoff, first pitch, tip-off, etc.)

In another embodiment, the decoder 102 may be instructed by a user where to insert the at least one prefix frame 204 and the at least one suffix frame 206 based on which frames of the video sequence 118 that the user wants to watch. For example, the user may specify to the decoder to start decoding with frame at time X of the video sequence 118 and stop decoding with frame at time Y of the video sequence 118. Those skilled in the art will recognize that there may be alternate ways for a user to instruct the decoder 102 on which frames of the video sequence 118 to start and stop encoding. The modified video sequence 118 may then be transmitted to encoder 104.

As discussed above, current transcoding methods create inefficiencies by transcoding unnecessary frames that a user may not want to watch. However, the present invention provides a solution to this problem by using the in-band information contained in the modified video sequence 118.

When the encoder 104 begins receiving the modified video sequence 118, the encoder 104 may detect the at least one prefix frame 204. For example, the encoder 104 may detect the at least one prefix frame 204 by looking for an active indicator box. In one embodiment, the active indicator box may be detected by the encoder 104 by detecting a pre-defined pattern and/or a value of the active indicator box within the at least one prefix frame 204 or in consecutive prefix frames 204, as discussed in further detail below with reference to FIG. 3. When the encoder 104 detects the at least one prefix frame 204, the encoder 104 is then able to accurately begin encoding the video sequence 118 beginning precisely with the first frame 122.

The encoder 104 continues to encode the plurality of frames 120 to precisely the last frame 124. The encoder 104 is able to accurately determine when it has reached the last frame 124 when the encoder 104 detects the at least one suffix frame 206. Similar to the at least one prefix frame 204, the encoder 104 may detect the at least one suffix frame 206 by looking for an active indicator box. When the encoder 104 detects the at least one suffix frame 206, the encoder 104 immediately stops encoding the video sequence 118 after encoding the last frame 124.

The characteristics of the at least one prefix frame 204 and the at least one suffix frame 206 may be communicated to both the decoder 102 and the encoder 104 prior to the start of the transcoding process e.g. by controller 108. As such, the decoder 102 may insert a proper at least one prefix frame 204 and at least one suffix frame 206 with characteristics that the encoder 104 will recognize as the at least one prefix frame 204 and the at least one suffix frame 206 for detection purposes. Once the transcoding process is completed by encoder 104, the at least one prefix frame 204 and at least one suffix frame 206 may be removed from the video sequence 118 at the encoder 104. Subsequently, the at least one prefix frame 204 and at least one suffix frame 206 may be discarded.

Consequently, the video sequence 118 may be transcoded into a second format as depicted by video sequence 218 in FIG. 2. The second format may be for example, H.264, MPEG 4, advanced audio coding or MP3. The video sequence 218 may contain fewer frames than the video sequence 118 to be compatible for display on the portable media device 116, e.g. if the portable media device operates at a lower frame rate or at a lower resolution. Thus, the video sequence 218 may have a lower number of frames 120 after transcoding to accommodate the capability of the portable media device 116.

The video sequence 218 may be outputted from the encoder 104 to a storage medium 210. The storage medium 210 may be the same storage medium as the storage medium 202. Alternatively, the storage medium 210 may be a storage medium of the portable media device 116 or a portable storage medium, such as for example, a memory card, as discussed above.

FIG. 3 illustrates an exemplary active indicator box 304 that may be found in the at least one prefix frame 204 or the at least one suffix frame 206. The active indicator box 304 comprises at least one pixel of the plurality of pixels 302. To illustrate by example, FIG. 3 depicts an active indicator box 304 that is a 100 pixels×100 pixels window located between pixel (309, 189) to pixel (409, 289). However, one skilled in the art will recognize that any number of pixels 302 may be used as the active indicator box 304. Furthermore, the active indicator box 304 may be located anywhere within the at least one prefix frame 204 or the at least one suffix frame 206 and that there may be more than one active indicator box 304. Moreover, the active indicator box 304 may be different for the at least one prefix frame 204 and the at least one suffix frame 206. The active indicator box 304 may even be different for consecutive prefix frames 204 or consecutive suffix frames 206.

As discussed above, the encoder 104 may detect the at least one prefix frame 204 or the at least one suffix frame 206 by detecting a pre-defined pattern of active indicator box 304. For example, the pre-defined pattern may be an active indicator box 304 having a checkered pattern, striped pattern or a color pattern. One skilled in the art will recognize that pre-defined pattern may be any pattern.

In addition, the active indicator box 304 may comprise a value. Typically, each of the plurality of pixels 302 comprises at least one type of information and a corresponding value of that type information. For example, the type information may be luminance (Y), chroma blue (C_{B}) or chroma red (C_{R}) for YUV type buffers or red, green or blue for RGB type buffers. The type information may have a corresponding value that is stored in each of the plurality of pixels 302. For example, if the active indicator box 304 is selected to have a window size of only a single pixel of the plurality of pixels 302, then the encoder 104 may be programmed such that the at least one prefix frame 204 is detected when the encoder 104 finds an active indicator box 304 having a pixel at location (0,0) with a blue value of 10 in an RGB type buffer.

The location of each of the plurality of pixels 302 is also known as the offset. The combination of the offset, type information and value is also known as an ordered triplet.

In addition, the encoder 104 may be programmed to detect the active indicator box 304 in consecutive prefix frames 204 and/or suffix frames 206. For example, the pre-defined pattern may be to locate the active indicator box 304 in three consecutive suffix frames 206 to prevent a “false positive” from occurring. To illustrate, the video sequence 118 may have a frame 120 that has a group of pixels 302 that by chance have the same pre-defined pattern and values as the active indicator box 304. This could cause the encoder 104 to begin encoding the video sequence 118 before the first frame 122 or stop encoding abruptly before the entire video sequence 118 is encoded to the last frame 124. To prevent the likelihood of this occurring, the encoder 104 may be programmed to look for the active indicator box 304 in consecutive prefix frames 204 or consecutive suffix frames 206, such as for example, locating the active indicator box 304 in three consecutive prefix frames 204 or suffix frames 206. Although three frames are used as an example, those skilled in the art will recognize that any number of consecutive prefix frames 204 or suffix frames 206 may be used.

As discussed above, the active indicator box 304 may be located anywhere in the at least one prefix frame 204 or the at least one suffix frame 206 and may contain any number of the plurality of pixels 302. This provides incredible flexibility for the present invention. For example, the active indicator box 304 may be changed for different video sequences 118 for any number of reasons, including but not limited to, contractual obligations or security reasons.

FIG. 4 illustrates exemplary virtual pixels 402 used in an exemplary embodiment of the present invention. In an exemplary embodiment of the present invention, virtual pixels 402 may be used to reduce the processing load of the encoder 104. To illustrate, after the encoder 104 detects the at least one prefix frame 204, the encoder 104 begins encoding the plurality of frames 120 of video sequence 118. However, the encoder 104 must simultaneously also scan and process each of the plurality of pixels 302 for each of the plurality of frames 120 to look for the active indicator box 304 to see if the encoder 104 has detected the at least one suffix frame 206 to stop encoding.

To minimize the effect of random noise the encoder 104 may process each of the plurality of frames 120 by using virtual pixels 402. The virtual pixels 402 may be an average of two or more pixels of the plurality of pixels 302. For example, if an active indicator box was 100 pixels×100 pixels, over 10,000 pixels would need to be processed and compared to determine if the encoder 104 has located an active indicator box 304. If random noise is introduced then it is possible that some of those 10,000 pixel values could be slightly corrupted, thereby leading to an erroneous analysis. However, the encoder 104 may average a group of four pixels and only be required to compare 2,500 averaged values to determine if an active indicator box 304 was located. Using the averaged values will minimize the effect of the random noise.

For example, as illustrated in FIG. 4, the shaded pixels may have values of 10, 2, 7 and 5. The average of the pixel values would then be equal to 6. This process could be repeated for the remaining pixels to determine if there is a group of virtual pixels 402 that has a value equal to the active indicator box 304 to indicate to the encoder 104 that at least one prefix frame 204 or at least one suffix frame 206 may have been detected. One skilled in the art will recognize that a tolerance value may be used as the virtual pixels are an average of the pixel values and may not identically match the values used to indicate an active indicator box 304.

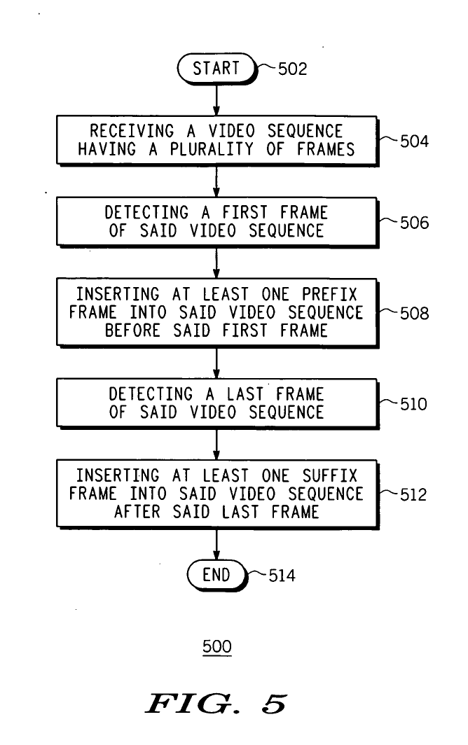

FIG. 5 illustrates an exemplary flow chart of a method 500 for processing a video sequence 118 having a plurality of frames 120. For example, method 500 can be implemented by decoder 102. Method 500 begins at step 502. At step 504 a video sequence 118 having a plurality of frames 120 is received.

At step 506 a first frame of the video sequence is detected. In one embodiment, the first frame may be detected by decoder 102 via information in the video sequence 118, e.g. a packet header indicating the beginning of a group of pictures or a video sequence identification. Alternatively, the first frame may be detected by decoder 102 by simply accessing the video sequence 118 from a local storage device.

At step 508 at least one prefix frame 204 is inserted into the video sequence 118. For example, the at least one prefix frame 204 may be inserted immediately before the first frame of the video sequence 118.

Subsequently, at step 510 the method detects a last frame of the video sequence 118.

At step 512, the method inserts at least one suffix frame 206 into the video sequence 118 after the last frame. For example, the at least one suffix frame 206 may be inserted immediately after the last frame of the video sequence 118. The method ends at step 514.

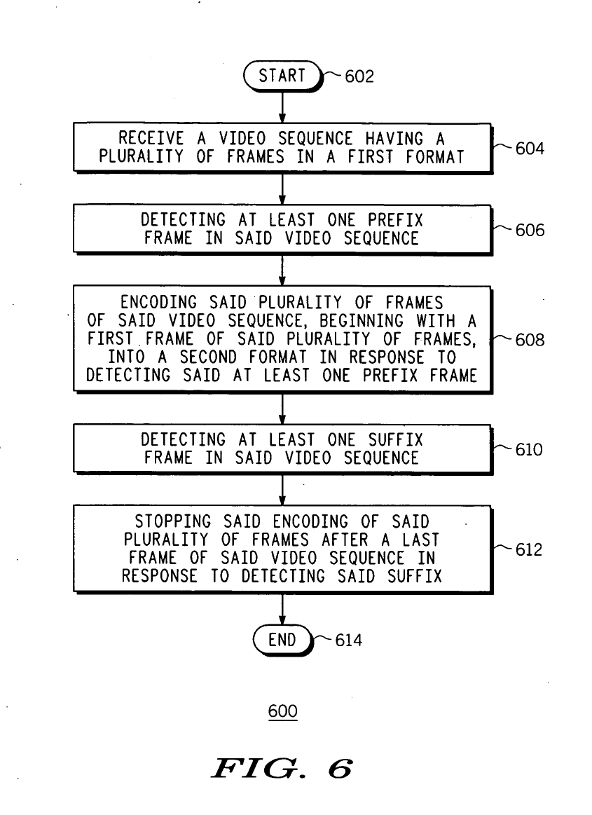

FIG. 6 illustrates an exemplary flow chart of a method 600 for processing a video sequence 118 having a plurality of frames 120. For example, method 600 can be implemented by encoder 104. Method 600 begins at step 602. At step 604 a video sequence 118 having a plurality of frames 120 in a first format is received.

Then, at least one prefix frame 204 is detected in the video sequence 118 at step 606.

Subsequently, at step 608 the method encodes the plurality of frames 120 of the video sequence 118, beginning with a first frame of the plurality of frames, into a second format in response to detecting the at least one prefix frame.

The method then detects at least one suffix frame in the video sequence 118 having the plurality of frames 120 at step 610.

The method concludes at step 612, by stopping the encoding of the plurality of frames after a last frame of the video sequence in response to detecting the suffix. The method ends at step 614.

It should be noted that although not specifically specified, one or more steps of method 500 and 600 may include a storing, displaying and/or outputting step as required for a particular application. In other words, any data, records, fields, and/or intermediate results discussed in the method can be stored, displayed and/or outputted to another device as required for a particular application. Furthermore, steps or blocks in FIGS. 5 and 6 that recite a determining operation or involve a decision do not necessarily require that both branches of the determining operation be practiced. In other words, one of the branches of the determining operation can be deemed as an optional step.

FIG. 7 illustrates a high level block diagram of an exemplary general purpose computer suitable for use in performing the functions described herein. As depicted in FIG. 7, the general purpose computer 700 comprises a processor element 702 (e.g., a CPU), a memory 704, e.g., random access memory (RAM) and/or read only memory (ROM), a transcoder module 112 for transcoding a video sequence, and various input/output devices 706 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the processes provided by the present transcoder module 112 can be loaded into memory 704 and executed by processor 702 to implement the functions as discussed above. As such, the processes provided by the transcoder module 112 for transcoding a video sequence having a plurality of frames of the present invention can be stored on a computer readable medium or carrier, e.g., RAM memory, magnetic or optical drive or diskette and the like.

While the foregoing is directed to illustrative embodiments of the present invention, other and further embodiments of the invention may be devised without departing from the basic scope thereof, and the scope thereof is determined by the claims that follow.

What is claimed is:

1. A method of transcoding a video sequence having a plurality of frames, comprising:
receiving said video sequence having said plurality of frames in a first format;
detecting at least one prefix frame in said video sequence;
encoding said plurality of frames of said video sequence, beginning with a first frame of said plurality of frames, into a second format in response to detecting said at least one prefix frame;
detecting at least one suffix frame in said video sequence; and
stopping said encoding of said plurality of frames after a last frame of said video sequence in response to detecting said at least one suffix frame.

2. The method of claim 1, wherein said video sequence having a plurality of frames is a decoded video sequence.

3. The method of claim 1, wherein said first format comprises uncompressed raw video.

4. The method of claim 1, wherein said at least one prefix frame comprises at least one active indicator box having at least one pixel in a pre-determined pattern.

5. The method of claim 4, wherein said at least one active indicator box is defined by an ordered triplet comprising at least on of an offset, a type information and a value.

6. The method of claim 1, wherein said at least one suffix frame comprises at least one active indicator box having at least one pixel in a pre-determined pattern.

7. The method of claim 6, wherein said at least one active indicator box is defined by an ordered triplet comprising at least on of an offset, a type information and a value.

8. The method of claim 1, wherein said at least one prefix frame and said at least one suffix frame are generated and inserted by a decoder.

9. The method of claim 1, further comprising:
removing said at least one prefix frame and said at least one suffix frame from said video; and
outputting said video sequence having said plurality of frames in said second format.

10. A system for transcoding a video sequence having a plurality of frames, comprising:
a decoder comprising a first processor for generating and inserting at least one prefix frame and at least one suffix frame in said video sequence having said plurality of frames in a first format; and
an encoder comprising a second processor for encoding said plurality of frames of said video sequence in said first format into a second format, wherein said encoder begins encoding when said at least one prefix frame is detected beginning with a first frame of said plurality of frames and stops encoding when said at least one suffix frame is detected after a last frame of said plurality of frames.

11. The system of claim 10, wherein said at least one prefix frame comprises at least one active indicator box having at least one pixel in a pre-determined pattern.

12. The system of claim 11, wherein said at least one active indicator box is defined by an ordered triplet comprising at least on of an offset, a type information and a value.

13. The system of claim 10, wherein said at least one suffix frame comprises at least one active indicator box having at least one pixel in a pre-determined pattern.

14. The system of claim 13, wherein said at least one active indicator box is defined by an ordered triplet comprising at least on of an offset, a type information and a value.

15. A computer-readable medium having stored thereon a plurality of instructions, said plurality of instructions including instructions which, when executed by a processor, cause said processor to perform said steps of a method of transcoding a video sequence having a plurality of frames, comprising:
receiving said video sequence having said plurality of frames in a first format;
detecting at least one prefix frame in said video sequence;
encoding said plurality of frames of said video sequence, beginning with a first frame of said plurality of frames, into a second format in response to detecting said at least one prefix frame;
detecting at least one suffix frame in said video sequence; and
stopping said encoding of said plurality of frames after a last frame of said video sequence in response to detecting said at least one suffix frame.

16. The computer readable medium of claim 15, wherein said at least one prefix frame comprises at least one active indicator box having at least one pixel in a pre-determined pattern.

17. The computer readable medium of claim 16, wherein said at least one active indicator box is defined by an ordered triplet comprising at least on of an offset, a type information and a value.

18. The computer readable medium of claim 15, wherein said at least one suffix frame comprises at least one active indicator box having at least one pixel in a pre-determined pattern.

19. The computer readable medium of claim 18, wherein said at least one active indicator box is defined by an ordered triplet comprising at least on of an offset, a type information and a value.

20. A method of transcoding a video sequence having a plurality of frames, comprising:
receiving a video sequence having a plurality of frames;
detecting a first frame of said video sequence;
inserting at least one prefix frame into said video sequence before said first frame;
detecting a last frame of said video sequence; and
inserting at least one suffix frame into said video sequence after said last frame.
